(19) United States
(12) Patent Application Publication
(10) Pub. No.: US 2026/0266775 A1
(43) Pub. Date: Sep. 10, 2026

(54) SAMPLE SUBMISSION FOR FORMULATED INJECTABLES

(71) Applicant: Waters Technologies Corporation, Milford, MA (US)

(72) Inventor: Michael O. Fogwill, Uxbridge, MA (US)

(21) Appl. No.: 19/555,256

(22) Filed: Mar. 3, 2026

Related U.S. Application Data
(60) Provisional application No. 63/766,764, filed on Mar. 4, 2025.

(51) Int. Cl. G01N 30/24; B01D 15/14; G01N 30/02; G01N 30/16

(52) U.S. Cl. CPC G01N 30/24; B01D 15/14; G01N 30/16; G01N 2030/027

(57) ABSTRACT

A sample plate for liquid chromatography includes a base including a plurality of wells each configured to receive a container. The base is configured to be submitted to a sample manager of a liquid chromatography system for processing samples. The plurality of wells includes: a first plurality of wells each configured to receive a formulated injectable container. A method of sample submission for formulated injectables comprises submitting a sample plate to a sample manager of a liquid chromatography system, the sample plate including a first plurality of wells each receiving a formulated injectable container and automatically processing the formulated injectable containers by the sample manager. A liquid chromatography sample manager system including the sample plate is further disclosed.

### RELATED APPLICATION

This application claims priority to U.S. Provisional Patent Application No. 63/766,764 filed on Mar. 4, 2025, the entirety of which is incorporated by reference herein.

### FIELD OF THE INVENTION

The disclosed technology generally relates to liquid chromatography. More particularly, the technology relates to methods and systems for submitting formulated injectables to an automated sample manager when using liquid chromatography (LC) testing.

### BACKGROUND

There is a need in the art of liquid chromatography (LC) for improved solutions to apply in quality assurance and quality control (QA/QC) labs for injectable substances. Injectable substance samples often require dilution and injection to complete the QA/QC parts of the manufacturing process. Traditional workflows require significant manual manipulation of injectables prior to incorporation of the sample into a liquid chromatography flow (i.e. injection into an LC system). This may, for example, require several manual transfers from an original packaging to a dilution container, and from a dilution container to LC vials which are then placed on instrument trays which are finally put into an LC sample manager. All of this takes time and increases the possibility of error through manual intervention.

Therefore, improved devices and methods for performing LC testing on injectable substances with dilution would be well received in the art. Such improved devices and methods may include improved sample systems for formulated injectables, such as sample plates and methods for sample submission to a sample manager of an LC system.

### SUMMARY

In one aspect, a sample plate for liquid chromatography includes a base including a plurality of wells each configured to receive a container, the base configured to be submitted to a sample manager of a liquid chromatography system for processing samples. The plurality of wells includes: a first plurality of wells each configured to receive a formulated injectable container.

Additionally or alternatively, the plurality of wells further includes at least one standard well configured to receive standard lab vials or direct samples.

Additionally or alternatively, the at least one standard well is configured to receive the standard lab vials.

Additionally or alternatively, the at least one standard well is raised in the base relative to the first plurality of wells such that the formulated injectable containers received in the first plurality of wells and the at least one standard lab vial received in the at least one standard well include a uniform or substantially uniform height when received in the base.

Additionally or alternatively, the first plurality of wells and the at least one standard well are each molded into the base.

Additionally or alternatively, the first plurality of wells includes between 8 and 20 injectable wells, and wherein the at least one standard well includes between 4 and 12 standard wells.

Additionally or alternatively, the first plurality of wells each include a compliant needle stopper configured to plug and/or hold a needle of the formulated injectable containers.

Additionally or alternatively, the first plurality of wells includes a compliant receptacle structure configured to hold a portion of the formulated injectable containers.

Additionally or alternatively, the formulated injectable container is selected from the group consisting of a 10 mL formulated injectable container, a 3 mL formulated injectable container, and a 2 mL formulated injectable container with an integrated needle.

In another aspect, a method of sample submission for formulated injectables includes submitting a sample plate to a sample manager of a liquid chromatography system, the sample plate including a first plurality of wells each receiving a formulated injectable container; and automatically processing the formulated injectable containers by the sample manager.

Additionally or alternatively, the automatically processing the formulated injectable containers by the sample manager further comprises: piercing a septum of each of the formulated injectable containers by a sample or puncture needle within the sample manager.

Additionally or alternatively, the automatically processing the formulated injectable containers by the sample manager further comprises: drawing a sample of each of the formulated injectable containers by the sample needle within the sample manager.

Additionally or alternatively, the automatically processing the formulated injectable containers by the sample manager further comprises: injecting, by the sample manager, the sample of each of the formulated injectable containers into a chromatographic flow of the liquid chromatography system.

Additionally or alternatively, the automatically processing the formulated injectable containers by the sample manager further comprises: diluting, by the sample manager, the sample from at least one of the formulated injectable containers.

Additionally or alternatively, the plurality of wells further includes at least one standard well receiving a standard lab vial or a direct sample, the method further comprises: automatically processing a substance from the standard lab vial or the direct sample by the sample manager.

Additionally or alternatively, the method further includes removing the sample plate from the sample manager; submitting a second sample plate to the sample manager of the liquid chromatography system, the second sample plate including a second plurality of wells each receiving a second formulated injectable container of a different type than the formulated injectable container; and automatically processing the formulated injectable containers by the sample manager.

In another aspect, a liquid chromatography sample manager system includes a sample plate including: a base including a plurality of wells each configured to receive a container, the base configured to be provided to a sample manager of a liquid chromatography system for processing samples, wherein the plurality of wells includes a first plurality of wells each configured to receive a formulated injectable container; and an automated needle system configured to, without human intervention, process samples from the sample submission plate.

Additionally or alternatively, the plurality of wells further includes: at least one standard well configured to receive standard lab vials or direct samples.

Additionally or alternatively, the at least one standard well is configured to receive the standard lab vials.

Additionally or alternatively, the at least one standard vial well is raised in the base relative to the first plurality of wells such that the formulated injectable containers received in the first plurality of wells and the at least one standard lab vial received in the at least one standard vial well include a uniform or substantially uniform height when received in the base.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 depicts a schematic representation of a liquid chromatography system, in accordance with one embodiment.

FIG. 2 depicts a plurality of formulated injectable containers, in accordance with one embodiment.

FIG. 3 depicts a standard lab vial, in accordance with one embodiment.

FIG. 4 depicts a side view of a sample plate for liquid chromatography, in accordance with one embodiment.

FIG. 5 depicts a side view of a sample plate for liquid chromatography, in accordance with one embodiment.

FIG. 6 depicts a side view of a sample plate for liquid chromatography, in accordance with one embodiment.

FIG. 7 depicts a side view of a sample plate for liquid chromatography, in accordance with one embodiment.

FIG. 8 depicts a side view of a sample plate for liquid chromatography, in accordance with one embodiment.

FIG. 9 depicts a method of sample submission for formulated injectables for liquid chromatography processing, in accordance with one embodiment.

FIG. 10 depicts another method of sample submission for formulated injectables for liquid chromatography processing, in accordance with one embodiment.

FIG. 11 depicts another method of sample submission for formulated injectables for liquid chromatography processing, in accordance with one embodiment.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, embodiments described herein provide for providing an improved sample submission system for formulated injectables. The improved sample submission systems described herein may include improved sample submission plates and methods for sample submission to and/or into a sample manager (i.e. autosampler) of an LC system. Such improved formulated injectable sample submission systems may facilitate and enable the creation of a sample manager system that is capable of performing processing (i.e. sampling, vial puncturing, dilution, drawing, injecting, etc.) from the original injectable packaging in an automated manner requiring little or no manual intervention. Thus, the improved sample submission systems described herein are configured to minimize errors cause by human intervention and improve the overall performance of the LC system and the ensuing results.

Thus, embodiments described herein below provide for various embodiments of improved sample plate for liquid chromatography. The various plates described herein provide for a format for the submission of formulated injectable pharmaceuticals into an LC for analysis. In some embodiments, sample plates contemplated may be non-removable within a sample manager or autosampler. An example embodiment may, for example, submit 26 formulated injectable containers and 12 standard lab vials, containing blanks, and/or controls. As contemplated herein, plates may be provided for samples in various formulated containers such as vials, needles, and the like. The standards may be in the form of LC vials or as part of the plate (i.e. deep wells).

The various plates described herein may hold a plurality of formulated injectables (sample) and a plurality of standard lab vials (standards, controls, blanks, etc.). The plates may include holders for the standard lab vials, or may include wells in a molded portion of the plate. In some embodiments, the plate may only hold the formulated injectables without standard lab vials. However, in any case, the plate may be submitted to a sample manager system for LC analysis. Further, there may be a different plate formats for different injectable formats.

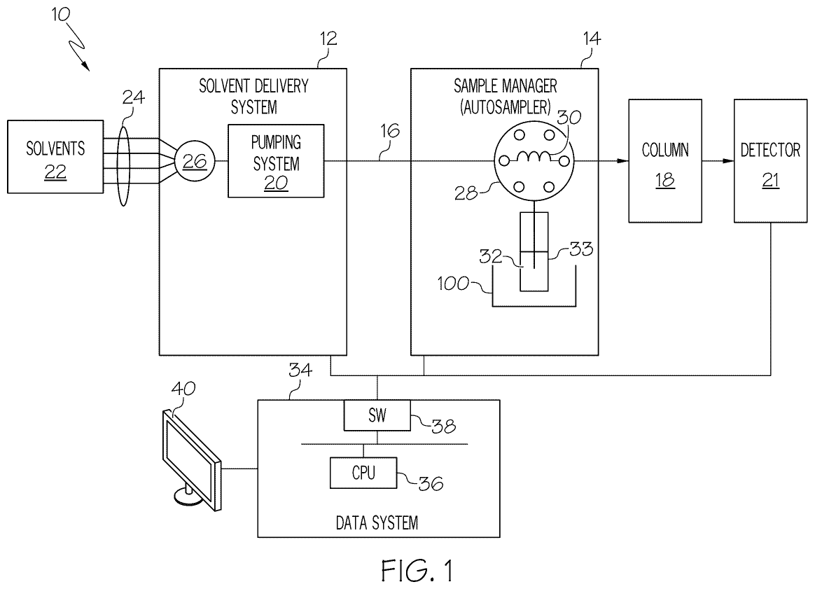

The features of the sample submission system and sample manager described herein may be applicable to any liquid chromatography system configured to deliver injectable samples into a chromatographic flow stream. As one example, FIG. 1 shows an embodiment of a liquid chromatography system 10 for separating a mixture into its constituents. The liquid chromatography system 10 includes a solvent delivery system 12 in fluidic communication with a sample manager 14 (also called an injector or an autosampler) through tubing 16. The sample manager 14 is in fluidic communication with a chromatographic column 18. A detector 21 for example, a mass spectrometer, is in fluidic communication with the column 18 to receive the elution.

The solvent delivery system 12 includes a pumping system 20 in fluidic communication with solvent reservoirs 22 from which the pumping system 20 draws solvents (liquid) through tubing 24. In one embodiment, the pumping system 20 is embodied by a low-pressure mixing gradient pumping system having two pumps fluidically connected in series. In the low-pressure gradient pumping system, the mixing of solvents occurs before the pump, and the solvent delivery system 12 has a mixer 26 in fluidic communication with the solvent reservoirs 22 to receive various solvents in metered proportions. This mixing of solvents (mobile phase) composition that varies over time (i.e., the gradient).

The pumping system 20 is in fluidic communication with the mixer 26 to draw a continuous flow of gradient therefrom for delivery to the sample manager 14. Examples of solvent delivery systems that can be used to implement the solvent delivery system 12 include, but are not limited to, the ACQUITY Binary Solvent Manager and the ACQUITY Quaternary Solvent Manager, manufactured by Waters Corp. of Milford, Mass.

The sample manager 14 may include an injector valve 28 having a sample loop 30. The sample manager 14 operates in one of two states: a load state and an injection state. In the load state, the position of the injector valve 28 is such that the sample manager loads the sample 32 into the sample loop 30. The sample 32 is drawn from a vial contained by a sample vial carrier. “Sample vial carrier” herein means any device configured to carry a sample vial such as a well plate, sample vial carrier, or the like. In the injection state, the position of the injector valve 28 changes so that the sample manager 14 introduces the sample in the sample loop 30 into the continuously flowing mobile phase from the solvent delivery system. The mobile phase thus carries the sample into the column 18. In other embodiments, a flow through needle (FTN) may be utilized instead of a Fixed-Loop sample manager. Using an FTN approach, the sample may be pulled into the needle and then the needle may be moved into a seal. The valve may then be switched to make the needle in-line with the solvent delivery system.

The liquid chromatography system 10 further includes a data system 34 that is in signal communication with the solvent delivery system 12 and the sample manager 14. The data system 34 has a processor 36 and a switch 38 (e.g. an Ethernet switch) for handling signal communication between the solvent delivery system 12 and sample manager 14, as described herein. Signal communication among the various systems and instruments can be electrical or optical, using wireless or wired transmission. A host computing system 40 is in communication with the data system 34 by which a technician can download various parameters and profiles (e.g., an intake velocity profile) to the data system 34.

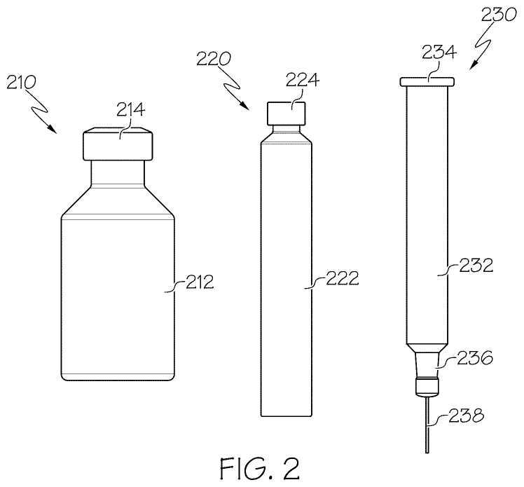

FIG. 2 depicts a plurality of formulated injectable containers, in accordance with one embodiment. In particular, shown is a first injectable container 210, a second injectable container 220, and a third injectable container 230. The first injectable container 210 may be a 10 mL injectable container including a main body 212 extending to a top 214. While not shown, the top 214 may include a septum configured to be received by a needle, for example. Likewise, the second injectable container 220 may be a 3 mL injectable container including a main body 222 extending to a top 224 which may include its own septum configured to be received by a needle. Still further, the third injectable container 230 may be a 2 mL formulated injectable container with an nitrated needle including a main body 232 extending to a top 234 which may include its own septum configured to be received by the needle. The third injectable container 230 extends to a bottom end 236 including its own needle 238 which may be used to inject the sample within the injectable container 230 in practice.

The plurality of formulated injectable containers 210, 220, 230 are shown for exemplary purposes. For the purposes of the present disclosure, formulated injectable containers are defined as any original pharmaceutical container or packaging created for the purpose of final customer distribution by a pharmaceutical manufacturer. Any formulated injectable container dimensions, sizes, or styles are contemplated by the embodiments described herein. In particular, submission plates described may include wells specifically dimensioned to accommodate formulated injectable containers of any known dimensions or configurations.

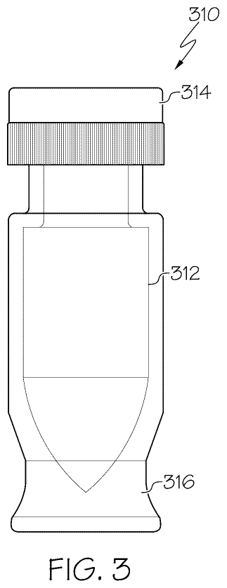

FIG. 3 depicts a standard lab vial 310, in accordance with one embodiment. The standard lab vial 310 may include its own main body extending between a lid 314 and a base 316. The standard lab vial 310 may be a standardized lab vial for liquid chromatography. Most commonly, a standard lab vial refers to a 2 mL clear glass vial with a 12 mm diameter and a 32 mm height commonly used in high performance liquid chromatography (HPLC) analysis. The standard lab vial 310 may include a screw cap 314 including a suitable septum for sample injection. However, the exact size of the standard lab vials described herein may deviate without departing from the scope of the description.

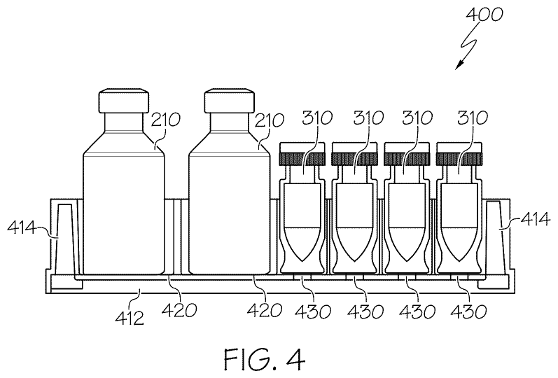

FIG. 4 depicts a side view of a sample plate 400 for liquid chromatography, in accordance with one embodiment. The sample plate 400 includes a base 412 having a side wall 414 structure extending around a perimeter of the base 412. The base 412 and/or sample plate 400 further includes a plurality of wells 420, 430 each configured to receive a container (hereinafter generically describing either the standardized lab vials 310 and/or the formulated injectable containers 210, 220, 230). The base 412 and/or sample plate 400 may be configured submitted to and/or inserted into a sample manager, such as the sample manager 14, of a liquid chromatography system for automated or automatic processing samples, such as the liquid chromatography system 10.

The plurality of wells 420, 430 includes a first plurality of wells 420 each configured to receive a formulated injectable container 210 (i.e. the 10 mL formulated injectable container described herein above). The plurality of wells 420, 430 may further include at least one standard vial well 430 each well configured to receive a standard lab vial. As shown, the plurality of standard vial wells 430 includes four separate standard vial wells 430. However, while not shown from the side view, the sample plate 400 may include several rows of the six wells 420, 430 shown. For example, in a four row plated embodiment, the sample plate 400 may include eight total formulated injectable wells 420 and sixteen standard vial wells 430. However, any combination or number of wells may be contemplated. For example, in contemplated embodiments, the plurality of formulated injectable wells 420 may include between 8 and 20 injectable wells 420, and the number of standard vial wells 430 may include between 4 and 12 standard vial wells. However, other embodiments having more or less formulated injectable wells 420 and/or standard vial wells 430 are contemplated.

The formulated injectable wells 420 and the standard vial wells 430 may be each molded into the base 412 of the sample plate 400 in one embodiment. In another embodiment, the formulated injectable wells 420 and the standard vial wells 430 may be provided by a separate array of wells or openings which are attached and/or otherwise received within the confines of the side walls 414 of the base 412. Whatever the embodiment, the sample plate 400 may provide for a plurality of formulated injectable wells for automated or automatic processing a plurality of formulated injectable containers in bulk by a sample manager and/or LC system.

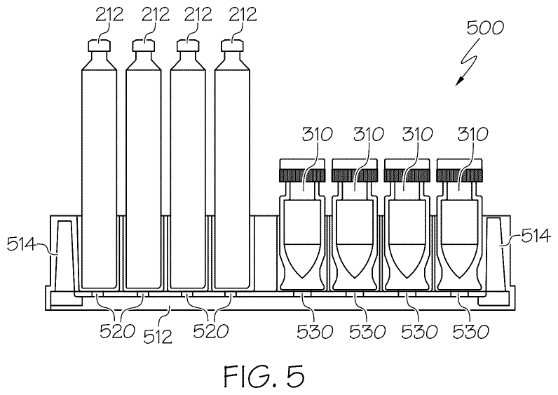

FIG. 5 depicts a side view of another sample plate 500 for liquid chromatography, in accordance with one embodiment. The sample plate 500 may be similar to the sample plate 400 of FIG. 4. Thus, the sample plate 500 includes a base 512 having a side wall 514 structure extending around a perimeter of the base 512. The base 512 and/or sample plate 500 further includes a plurality of wells 520, 530 each configured to receive a container. The base 512 and/or sample plate 500 may be configured to be submitted to and/or inserted into a sample manager, such as the sample manager 14, of a liquid chromatography system for automated or automatic processing samples, such as the liquid chromatography system 10.

The plurality of wells 520, 530 includes a plurality of formulated injectable wells 520 each configured to receive a formulated injectable container 220 (i.e. the 3 mL formulated injectable container described herein above). The plurality of wells 520, 530 may further include at least one standard vial well 530 each well configured to receive a standard lab vial. As shown, the plurality of standard vial wells 530 includes four separate standard vial wells 530 in each row. Likewise, the formulated injectable wells 520 includes four separate wells in each row. Thus, unlike the embodiment in FIG. 4, the sample plate 500 may be configured to receive the smaller formulated injectable containers 220.

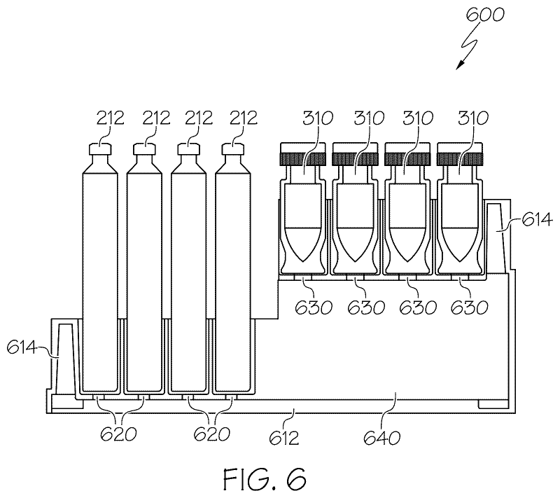

FIG. 6 depicts a side view of a sample plate 600 for liquid chromatography, in accordance with one embodiment. The sample plate 600 may be similar to the sample plates 400, 500 of FIGS. 4 and 5. Thus, the sample plate 600 includes a base 612 having a side wall 614 structure extending around a perimeter of the base 612. The base 612 and/or sample plate 600 further includes a plurality of wells 620, 630 each configured to receive a container. The base 612 and/or sample plate 600 may be configured to be submitted to and/or inserted to a sample manager, such as the sample manager 14, of a liquid chromatography system for automated or automatic processing samples, such as the liquid chromatography system 10.

The plurality of wells 620, 630 includes a plurality of formulated injectable wells 620 each configured to receive a formulated injectable container 220 (i.e. the 3 mL formulated injectable container described herein above). The plurality of wells 620, 630 may further include at least one standard vial well 630 each well configured to receive a standard lab vial. As shown, the plurality of standard vial wells 630 includes four separate standard vial wells 630 in each row. Likewise, the formulated injectable wells 620 includes four separate wells in each row.

However, unlike the embodiment in FIGS. 4 and 5, the standard vial wells 630 are raised in the base 612 relative to the plurality of formulated injectable wells 620 such that the formulated injectable containers 220 received in the plurality of formulated injectable wells 620 and the standard lab vials 310 received in the standard vial wells 530 include a uniform or substantially uniform height when received in the base 612. Hereinafter “substantially uniform” may mean a height which is within the ability of a sample needle system to operate on the septa of the formulated injectables without significant movement in the vertical direction. For example, a substantially uniform height may be within a one or two millimeter range. To provide for the uniform or substantially uniform height, the base 612 includes a raised portion 640 which raises the height of the bottom of the standard vial wells 530 in order to raise the standard lab vials 530 to the height of the formulated injectable containers 220. This raised embodiment may be used to create a plate which raises (or lowers) the standard vial wells and/or the formulated injectable wells in order to maintain a uniform height of each of the various containers held by the sample plate 600.

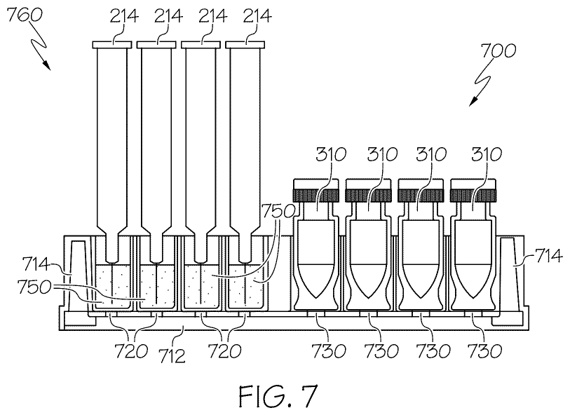

FIG. 7 depicts a side view of a sample plate 700 for liquid chromatography, in accordance with one embodiment. The sample plate 700 may be similar to the sample plates 400, 500, 600 of FIG. 4-6. Thus, the sample plate 700 includes a base 712 having a side wall 714 structure extending around a perimeter of the base 712. The base 712 and/or sample plate 700 further includes a plurality of wells 720, 730 each configured to receive a container. The base 712 and/or sample plate 700 may be configured to be inserted or submitted to a sample manager, such as the sample manager 14, of a liquid chromatography system for automated or automatic processing samples, such as the liquid chromatography system 10.

The plurality of wells 720, 730 includes a plurality of formulated injectable wells 720 each including a compliant needle stopper 750 configured to receive the needle 238 of the formulated injectable container 220 (i.e. the 2 mL needled formulated injectable container described herein above). The plurality of wells 720, 730 may further include at least one standard vial well 730 each well configured to receive a standard lab vial. As shown, the plurality of standard vial wells 730 includes four separate standard vial wells 730 in each row. Likewise, the formulated injectable wells 720 includes four separate wells in each row.

Thus, unlike the embodiment in FIG. 4-6, the sample plate 700 may include a needled container portion 760 which may be configured to receive the needled formulated injectable containers 230. The compliant needle stopper 750 may be made of a foam or polymeric material configured to have compliance. The compliant needle stopper 750 may include an opening configured to receive the needle therein and provide support for the needle. While not shown, the compliant needle stopper 750 may include a foam cutout which accommodates the dimensions of the bottom end 236 of the formulated injectable containers 230 as well to help maintain the formulated injectable containers 230 upright within the well. Furthermore, a rubber stopper structure may be configured to hold the received formulated injectable containers closer to the septum end 234.

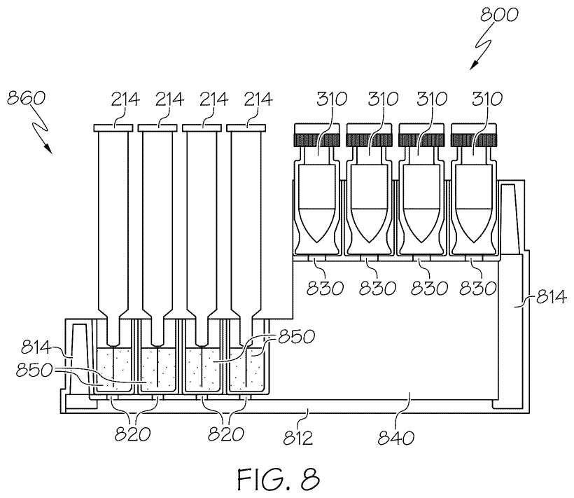

FIG. 8 depicts a side view of a sample plate for liquid chromatography, in accordance with one embodiment. The sample plate 800 may be similar to the sample plates 400, 500, 600, 700 of FIG. 4-7. Thus, the sample plate 800 includes a base 812 having a side wall 814 structure extending around a perimeter of the base 812. The base 812 and/or sample plate 800 further includes a plurality of wells 820, 830 each configured to receive a container. The base 812 and/or sample plate 800 may be configured to be inserted into and/or submitted to a sample manager, such as the sample manager 14, of a liquid chromatography system for automated or automatic processing samples, such as the liquid chromatography system 10.

The plurality of wells 820, 830 includes a plurality of formulated injectable wells 820 each including a compliant needle stopper 850 configured to receive the needle 238 of the formulated injectable container 220 (i.e. the 2 mL needled formulated injectable container described herein above). The plurality of wells 820, 830 may further include at least one standard vial well 830 each well configured to receive a standard lab vial. As shown, the plurality of standard vial wells 830 includes four separate standard vial wells 830 in each row. Likewise, the formulated injectable wells 820 includes four separate wells in each row.

Like the embodiment of FIG. 7, the sample plate 800 may include a needled container portion 860 which may be configured to receive the needled formulated injectable containers 230. The compliant needle stopper 850 may be made of a foam or polymeric material configured to have compliance. The compliant needle stopper 850 may include an opening configured to receive the needle therein and provide support for the needle. While not shown, the compliant needle stopper 850 may include a foam cutout which accommodates the dimensions of the bottom end 236 of the formulated injectable containers 230 as well to help maintain the formulated injectable containers 230 upright within the well. Furthermore, a rubber stopper structure may be configured to hold the received formulated injectable containers closer to the septum end 234.

Moreover, like the embodiment of FIG. 6, the standard vial wells 830 are raised in the base 812 relative to the plurality of formulated injectable wells 820 such that the formulated injectable containers 230 received in the plurality of formulated injectable wells 820 and the standard lab vials 310 received in the standard vial wells 830 include a uniform height when received in the base 812. In particular, the base 812 includes a raised portion 840 which raises the height of the bottom of the standard vial wells 830 in order to raise the standard lab vials 830 to the height of the formulated injectable containers 220. This raised embodiment may be used to create a plate which raises (or lowers) the standard vial wells and/or the formulated injectable wells in order to maintain a uniform height of each of the various containers held by the sample plate 800.

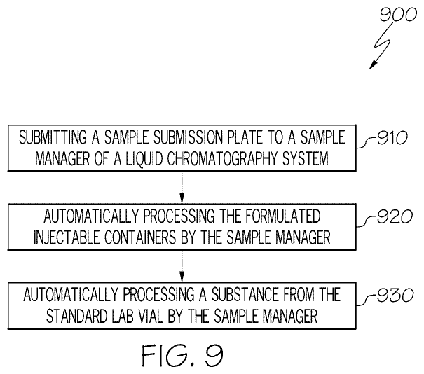

FIG. 9 depicts a method 900 of sample submission for formulated injectables for liquid chromatography processing, in accordance with one embodiment. The method 900 includes a first step 910 of submitting a sample submission plate, such as one of the sample plates 400, 500, 600, 700, 800, into a sample manager, such as the sample manager 14, of a liquid chromatography system, such as the liquid chromatography system 10. The sample plate may include a plurality of formulated injectable wells each receiving a formulated injectable container. In some cases, the sample plate may include at least one standard vial well configured to receive standard lab vials.

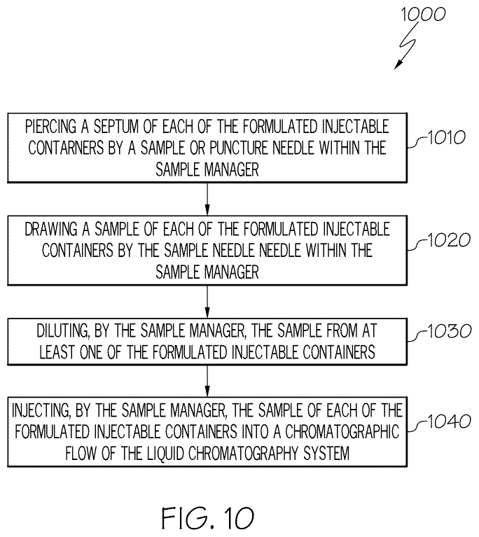

The method 900 may include a second step 920 of automatically processing (e.g., with an automated system of the sample manager) the formulated injectable containers by the sample manager. The step 920 is shown expanded in the methodology of FIG. 10, described herein below. In the optional embodiments that the sample plate includes the plurality of standard vial wells, the method 900 includes a further step 930 of automatically processing (e.g., with an automated system of the sample manager) the substance from the standard lab vial by the sample manager.

FIG. 10 depicts another method 1000 of sample submission for formulated injectables for liquid chromatography processing, in accordance with one embodiment. The method 1000 includes the various steps of processing the samples and/or substances found in the formulated injectables and/or standard lab vials described hereinabove.

In a first step 1010, the method 1000 includes piercing a septum of each of the formulated injectable containers and/or standard lab vial by a sample or puncture needle within the sample manager. The method 1000 may include a step 1020 of drawing a sample of each of the formulated injectable containers and/or standard lab vials by the sample needle within the sample manager. The method 1000 may include a step 1030 of diluting, by the sample manager, the sample from at least one of the formulated injectable containers and/or the substances from the standard lab vials. Further, the method 1000 may include a step 1040 of injecting, by the sample manager, the sample of each of the formulated injectable containers into a chromatographic flow of the liquid chromatography system.

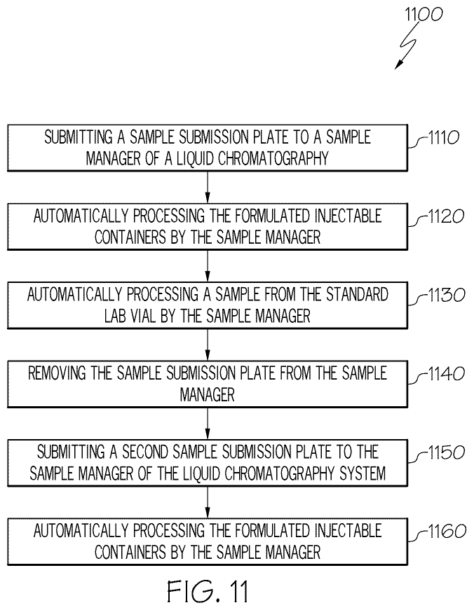

FIG. 11 depicts another method 1100 of sample submission for formulated injectables for liquid chromatography processing, in accordance with one embodiment. The method 1100 includes a first step 1110 of submitting a sample plate, such as one of the sample plates 400, 500, 600, 700, 800, into a sample manager, such as the sample manager 14, of a liquid chromatography system, such as the liquid chromatography system 10. The sample submission plate may include a plurality of formulated injectable wells each receiving a formulated injectable container. In some cases, the sample plate may include at least one standard vial well configured to receive standard lab vials.

The method 1100 may include a second step 1120 of automatically processing (e.g., with an automated system of the sample manager) the formulated injectable containers by the sample manager. The step 1120 is shown expanded in the methodology of FIG. 10, described herein above. In the optional embodiments that the sample plate includes the plurality of standard vial wells, the method 1100 includes a further step 1130 of automatically processing (e.g., with an automated system of the sample manager) the substance from the standard lab vial by the sample manager.

The method 1100 may further include a step 1140 of removing the sample plate from the sample manager and a following step 1150 of submitting a second sample plate into the sample manager of the liquid chromatography system. The second sample plate including a second plurality of formulated injectable wells each receiving a second formulated injectable container of a different type than the formulated injectable container. Thus, the method 1100 contemplates that the same sample manager may be configured to receive and automatically process different sample plates having different dimensions and receiving different formulated injectable containers. The method 1100 may thus include a step 1160 of automatically processing the formulated injectable containers from the second sample plate by the sample manager.

While various examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. A sample plate for liquid chromatography comprising:
a base including a plurality of wells each configured to receive a container, the base configured to be submitted to a sample manager of a liquid chromatography system for processing samples, wherein the plurality of wells includes:
a first plurality of wells each configured to receive a formulated injectable container.

2. The sample plate of claim 1, wherein the plurality of wells further includes:
at least one standard well configured to receive standard lab vials or direct samples.

3. The sample plate of claim 2, wherein the at least one standard well is configured to receive the standard lab vials.

4. The sample plate of claim 3, wherein the at least one standard well is raised in the base relative to the first plurality of wells such that the formulated injectable containers received in the first plurality of wells and the at least one standard lab vial received in the at least one standard well include a uniform or substantially uniform height when received in the base.

5. The sample plate of claim 2, wherein the first plurality of wells and the at least one standard well are each molded into the base.

6. The sample plate of claim 2, wherein the first plurality of wells includes between 8 and 20 injectable wells, and wherein the at least one standard well includes between 4 and 12 standard wells.

7. The sample plate of 1, wherein the first plurality of wells each include a compliant needle stopper configured to plug and/or hold a needle of the formulated injectable containers.

8. The sample plate of claim 7, wherein the first plurality of wells includes a compliant receptacle structure configured to hold a portion of the formulated injectable containers.

9. The sample plate of claim 1, wherein the formulated injectable container is selected from the group consisting of a 10 mL formulated injectable container, a 3 mL formulated injectable container, and a 2 mL formulated injectable container with an integrated needle.

10. A method of sample submission for formulated injectables comprising:
submitting a sample plate to a sample manager of a liquid chromatography system, the sample plate including a first plurality of wells each receiving a formulated injectable container; and
automatically processing the formulated injectable containers by the sample manager.

11. The method of claim 10, wherein the automatically processing the formulated injectable containers by the sample manager further comprises:
piercing a septum of each of the formulated injectable containers by a sample or puncture needle within the sample manager.

12. The method of claim 11, wherein the automatically processing the formulated injectable containers by the sample manager further comprises:
drawing a sample of each of the formulated injectable containers by the sample needle within the sample manager.

13. The method of claim 12, wherein the automatically processing the formulated injectable containers by the sample manager further comprises:
injecting, by the sample manager, the sample of each of the formulated injectable containers into a chromatographic flow of the liquid chromatography system.

14. The method of claim 12, wherein the automatically processing the formulated injectable containers by the sample manager further comprises:
diluting, by the sample manager, the sample from at least one of the formulated injectable containers.

15. The method of claim 10, wherein the plurality of wells further includes at least one standard well receiving a standard lab vial or a direct sample, the method further comprising:
automatically processing a substance from the standard lab vial or the direct sample by the sample manager.

16. The method of claim 10, further comprising:
removing the sample plate from the sample manager;
submitting a second sample plate to the sample manager of the liquid chromatography system, the second sample plate including a second plurality of wells each receiving a second formulated injectable container of a different type than the formulated injectable container; and
automatically processing the formulated injectable containers by the sample manager.

17. A liquid chromatography sample manager system comprising:
a sample plate including:
a base including a plurality of wells each configured to receive a container, the base configured to be provided to a sample manager of a liquid chromatography system for processing samples, wherein the plurality of wells includes a first plurality of wells each configured to receive a formulated injectable container; and
an automated needle system configured to, without human intervention, process samples from the sample submission plate.

18. The liquid chromatography sample manager system of claim 17, wherein the plurality of wells further includes:
at least one standard well configured to receive standard lab vials or direct samples.

19. The liquid chromatography sample manager system of claim 18, wherein the at least one standard well is configured to receive the standard lab vials.

20. The liquid chromatography sample manager system of claim 19, wherein the at least one standard vial well is raised in the base relative to the first plurality of wells such that the formulated injectable containers received in the first plurality of wells and the at least one standard lab vial received in the at least one standard vial well include a uniform or substantially uniform height when received in the base.
